(19) United States
(12) Patent Application Publication
(10) Pub. No.: US 2005/0190264 A1
(43) Pub. Date: Sep. 1, 2005

(54) Method of interactive system for previewing and selecting eyewear

(76) Inventor: Michael R. Neal, Moosic, PA (US)

Correspondence Address: BLANK ROME LLP, 600 NEW HAMPSHIRE AVENUE, N.W., WASHINGTON, DC, 20037, US

(21) Appl. No.: 10/938,868

(22) Filed: Sep. 13, 2004

Related U.S. Application Data
(60) Provisional application No. 60/502,290, filed on Sep. 12, 2003.

(51) Int. Cl. G02C 1/00; H04N 5/225

(52) U.S. Cl. 348/207.1

(57) ABSTRACT

An interactive computer for selecting color contact lenses and eyeglass or sunglass frames having a touch screen display, a digital camera, and streaming video technology. The computer takes a picture of the user and displays it on the monitor. The user can then select contact lenses of different colors to try on. Similarly, the user can put on different eyeglass or sunglass frames and take pictures to be displayed on the monitor. In this way, the user can view his or her face wearing a series of different color contacts or eyeglass/sunglass frames to determine which color or style they prefer. Furthermore, the user can view his selections while having the benefit of wearing his prescription contact lenses or eyeglass so that his perception of his selections is not visually impaired.

### RELATED APPLICATION

This application claims the benefit of U.S. Provisional Patent Application Ser. No. 60/502,290 entitled Interactive System for Visual Corrective Selection, filed Sep. 12, 2003, the subject matter of which is herein incorporated by reference.

### FIELD OF THE INVENTION

The present invention relates to an interactive computer-enabled system for selecting visual corrective eyewear, particularly color contact lenses, and prescription eyeglasses and sunglasses.

### BACKGROUND OF THE INVENTION

Interactive computer systems are generally known in the art to enable users in becoming active participants in making purchasing decisions. Such systems are often found in point of purchase displays using computer systems that allow the consumer to preview goods before they are purchased.

For example, users who take digital photographs are able to go to computer display systems, view their pictures, edit them, and select which pictures they want to print and/or purchase. This allows user's to select only those pictures that they want and not waste money on printing or buying those picture they do not.

Another example are consumers who go to hair salons and have their picture taken and displayed on a computer screen. Different hair designs can be cropped onto the picture, allowing the consumer to view and select which hair design they prefer. This allows the consumer to view the hair design as it would look on them, without having to actually having their hair cut or styled.

These interactive systems allow consumers to make a more informed decision about the products they are purchasing, particularly when the product is unavailable or cannot be “tried on” without difficulty.

In the ophthalmic industry, point of purchase sales for corrective eyewear is by far the largest revenue generator for ophthalmic retailers, which include optometrists', ophthalmologists', and opticians' offices. The sale of these items, particularly color contact lenses, and prescription eyeglass and sunglass frames depend heavily on a consumer's personal tastes and preferences, with consumers often wanting to try on and view these items before purchasing them.

However, oftentimes it is difficult for the consumer to try on these items because the contact lens or eyeglass does not have the proper prescription for the consumer and the consumer is forced to evaluate these products while his vision is impaired. Thus, the purchaser will often rely on a companion or the staff working at the store/office in making their purchasing decision. A better and more intelligent process would be to allow a purchaser to view his or her color contact, eyeglass or sunglass frame under perfect visual acuity.

### SUMMARY OF THE INVENTION

Accordingly, it is an object of the present invention to provide a computer, program that aids a consumer in selecting a color contact lenses or eyeglass frames or lenses or sunglasses.

It is another object of the present invention to allow a consumer to wear his prescription contact lens or eyeglass frame while previewing color contact lenses or eyeglass and sunglass frames, so that he may have an unimpaired view of how he might look wearing different color contact lenses or eyeglass frames.

It is yet another object of the present invention to provide a computer program that is easy to use and is capable of being operated by anyone.

It is yet another object of the present invention to provide a computer program that does not require the assistance of any other individual other than the user.

The present invention provides for an interactive selection process and system for choosing cosmetic or corrective eyewear. The invention provides for a software program designed for use with a computer, touch screen display monitor, a digital camera, and streaming video technology.

The system works by inviting a user or consumer via motion detection to sit down at a computer where the program is running. The program asks the user if he or she is interested in color contact lenses or eyeglass frames. The user then touches the display to select one of these options and begin the program.

If the user selects color contacts, the digital camera takes a picture of the user and displays it on the monitor. Virtual contacts lenses are then placed on the picture of the user's eyes, with the user being able to change the color of the virtual contact lenses using an on-screen color palette. The user can than view the display of his appearance while trying on a variety of different color contacts lenses, and while wearing his prescription glasses or contact lenses so that his vision is not impaired. Additionally, this system eliminates the need for the user to physically try on pairs of contact lenses, allowing him to quickly preview a series of different color contacts to determine which color he prefers.

Similarly, if the user selects eyeglass frames, the digital camera takes a picture of the user trying on different frames. The pictures are then displayed simultaneously on the monitor for easy comparison, while the user is wearing his prescription eyeglass frames and his vision is unimpaired.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a computer display monitor of the present invention;

FIG. 2 shows a flow chart showing the steps in the lens camera system;

FIG. 3 shows a flow chart showing the steps in the frame camera system; and

FIGS. 4-19 shows an exemplary embodiments of the steps in FIGS. 2 and 3.

### DETAILED DESCRIPTION OF THE INVENTION

Referring now to the several drawing figures in which identical elements are numbered identically throughout, a description of the preferred embodiment of the present invention will be provided. The preferred embodiment of the invention is described for illustrative purposes, it being understood that the invention may be embodied in other forms not specifically shown in the drawings or described hereinafter.

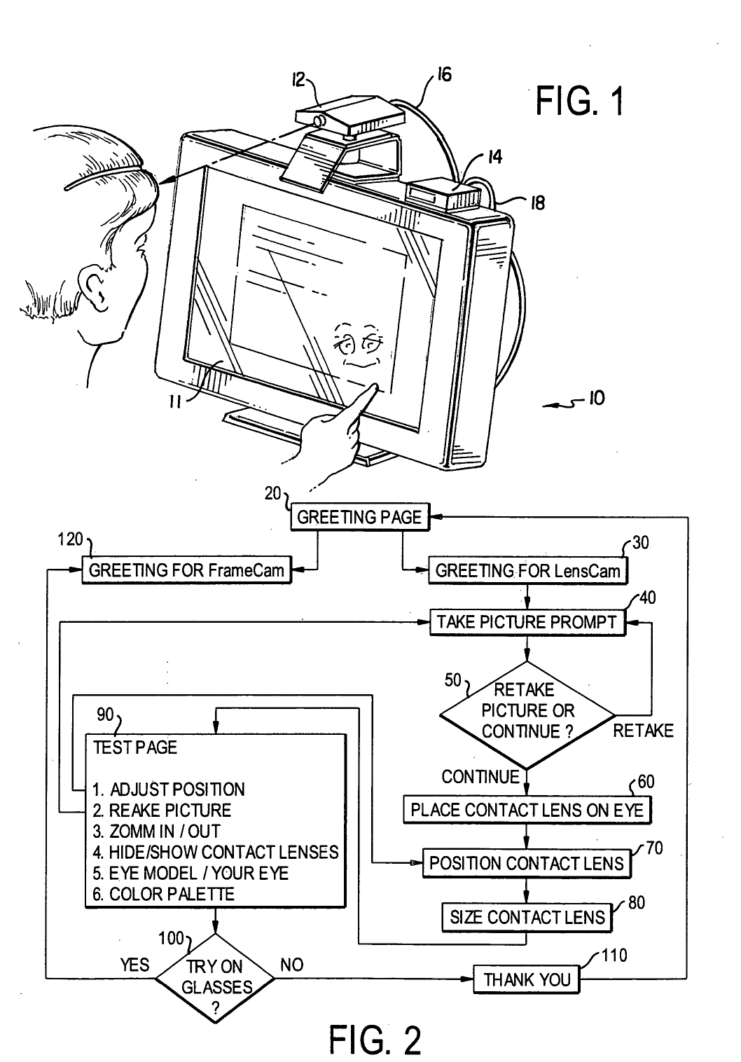

Referring now in detail to the drawings, FIGS. 1 shows a computer 10 having a digital camera 12 attached thereto. In the preferred embodiment, the computer 10 includes all the components of a typical computer system including a processor, memory storage devices and monitor 11. The computer 10 also includes data input/output ports, such as a CD-ROM drive and serial and USB ports for connection to other devices. Additionally, the monitor of the computer 10 is a touchscreen display, through which the user can input data and/or make selections by touching the screen.

In the preferred embodiment shown in FIG. 1, the camera 12 includes a Velcro™ attachment on the underside of its housing and is secured to the computer 10 via a corresponding Velcro™ attachment located thereon. The camera 12 is connected to the computer 10 by data cable 16, as is well known in the art. Additionally, a flash 14 is located adjacent the camera 12 and secured to the computer 10 using a similar Velcro™ attachment. The flash 14 is connected to the computer 10 using data cable 18 and is synchronized with the camera 12 so that it goes off when the picture is taken.

Typically, the computer 10, will be set-up in the office of an eye care professional who sells contact color contact lenses, eyeglass and sunglass frames. The computer 10 is loaded with a program containing a system for previewing both color contact lenses (hereinafter referred to as the “lens camera system”) and eyeglass frames (hereinafter referred to as the “frame camera system”).

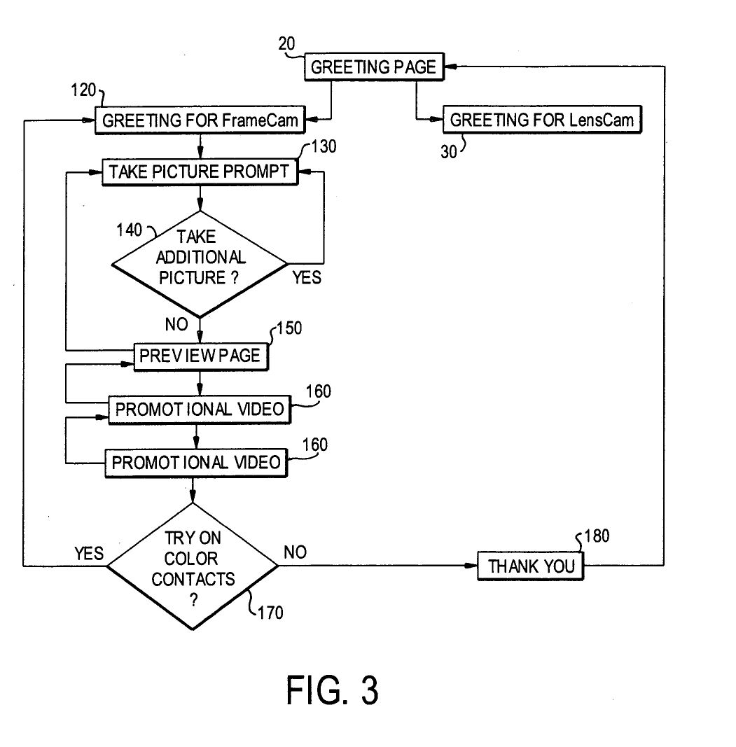

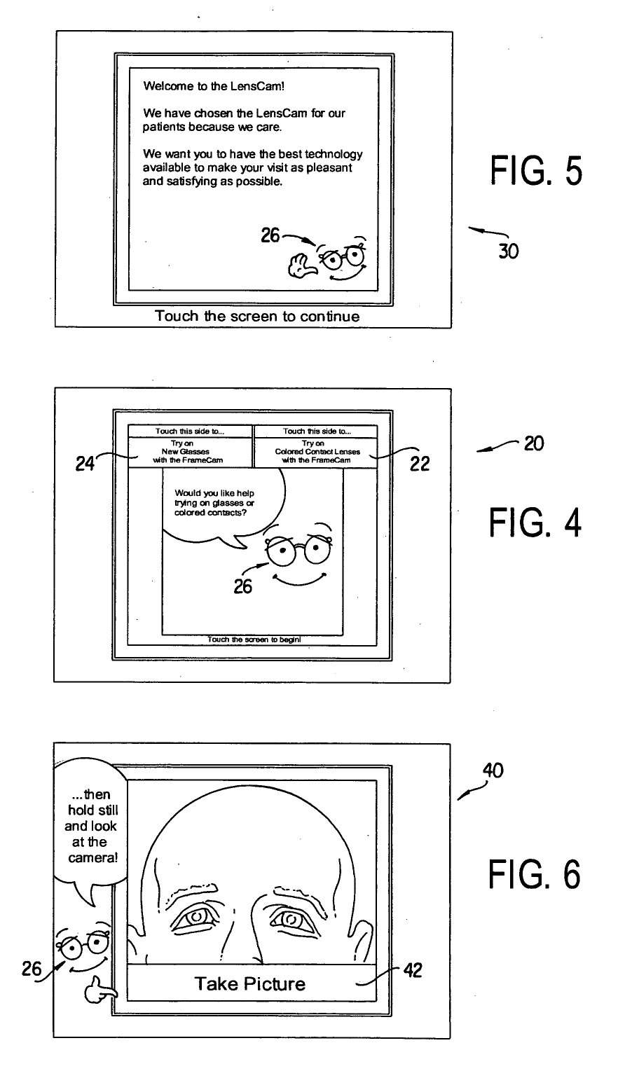

The computer program will now be described with reference to FIGS. 2 and 3, which shows flow charts of the sequence of steps in the program, and FIGS. 4-16, which show exemplary embodiments of what is actually shown on the monitor 11 during the various steps. FIG. 2 shows the flow chart for the lens camera system and FIG. 3 shows the flow chart for the frame camera system. Although the two flow charts are inter-related, they are separated and provided for in two figures for clarity. It should also be understood that the exemplary embodiments shown in FIGS. 4-16 are for illustrative purposes only, and are not meant to limit the scope of the invention. In particular, the wording, labels, arrangement and visual effects displayed on the monitor 11 are exemplary embodiments and may be changed or modified without departing from the scope of the invention.

The monitor 11 initially displays a greeting, as indicated by step 20 in the flow charts, inviting a user to try the program and asking whether they are interested in color contact lenses or eyeglass frames. An exemplary embodiment of the greeting display is shown in FIG. 4. The display includes a color contact lens prompt 22 and eyeglass frames prompt 24.

The system of the present invention also includes a motion detection feature so that when a user passes in view of the camera 12, the system will invite the user to try the lens camera and frame camera system.

Instructional or other information may be conveyed to the user via an onscreen assistant 26, who provides assistance to the user throughout the program. The onscreen assistant 26 is preferably a friendly animated cartoon character who guides the user through the program, offering helpful instruction and/or advice. The onscreen assistant 26 can relay information through both picture and sound, by displaying the information on the monitor 11 and through pre-recorded sound recordings. The onscreen assistant 26 eliminates the need of providing a person to assist the user through the program. The onscreen assistant 26 can provide instructions in various lanaguages. The language of the onscreen assistant 26 can be changed at any time or step of the program to any language without restarting the program.

If the user wants to preview color contact lenses, he simply touches the color contact lens prompt 22. A greeting for the lens camera system is then displayed, as indicated by step 30. An exemplary embodiment of the lenscam greeting display is shown in FIG. 5.

After the greeting, the lens camera system proceeds to the picture taking step 40. Here, the monitor 11 streams video from the camera 12, which typically will be the user sitting in front of the camera 12. An exemplary embodiment of the picture taking step 40 is shown in FIG. 6. The user will position his face in front of the camera so that his face is shown in the monitor 11, focus the camera 12, and then select a “Take Picture” prompt 42 on the monitor 11. The lens camera system will perform a short countdown, i.e., “3-2-1”, and then takes the user's picture.

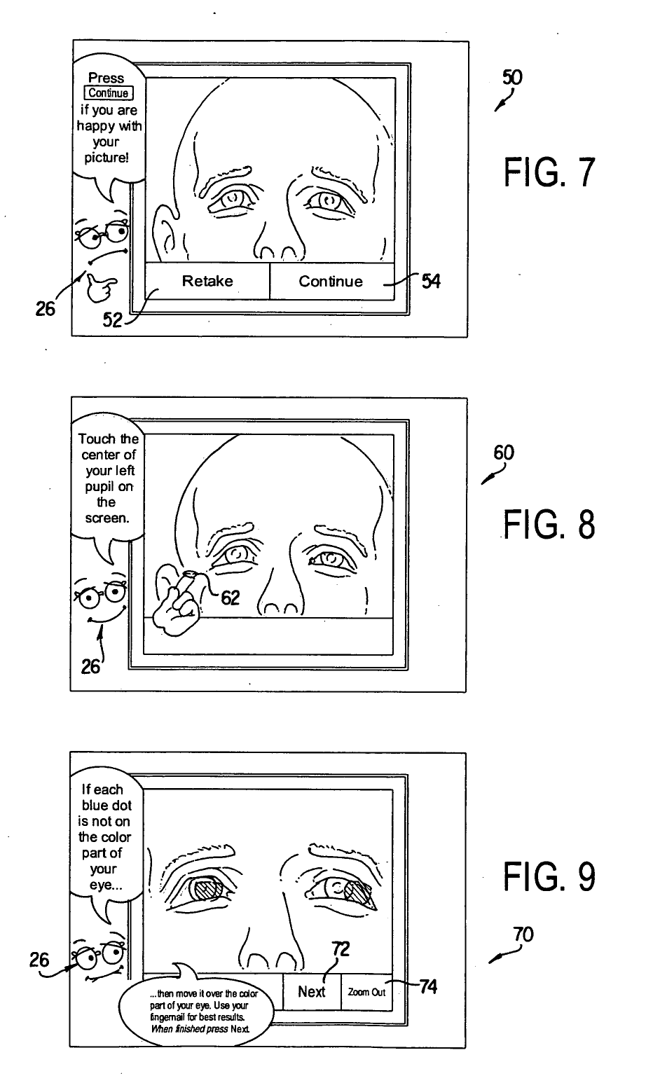

The picture is then displayed on the monitor 11, in a review step 50, for the user to evaluate the picture and determine whether to retake the picture or continue on with the program. An exemplary embodiment of the review step 50 is shown in FIG. 7. If the user is unhappy with the picture, he can select a “retake” prompt 52, which takes him to the previous step 40 so that another picture can be taken. If the user is satisfied with the picture, he can select a “continue” prompt 54, which takes him to the next step 60 of placing virtual contact lenses on his eyes in the displayed picture.

During the step 60, the onscreen assistant 26 instructs the user to touch the monitor 11 on first his left eye and then his right eye. An exemplary embodiment of the contact lens placement step 60 is shown in FIG. 8. This allows the computer to recognize the location of the user's eyes for placement of the virtual contact lenses 62.

However, during step 60, the contact lenses 62 may not be properly positioned on the user's eyes, and may require some adjustment. The program allows the user to touch the monitor 11 and “drag” the contact lenses 62 over the user's eyes, in repositioning step 70. An exemplary embodiment of the repositioning step 70 is shown in FIG. 9. Here, the user is directed by the onscreen assistant 26 to touch the monitor 11 and move the contact lens over the pupil of the eye.

An added feature during step 70 is the zoom in/out function. An alternating “Zoom In” and “Zoom Out” prompt 74 (“Zoom Out” shown in FIG. 9) is provided at this step which alternates between a close up and distant picture of the user's face. The zoom-in or close-up picture of the user's face allows the user to more accurately position the contact lenses 62. The zoom-out or distant picture allows the user to get a better view of the overall appearance of his face. The zoom in/out feature is provided at several other steps in the program, with their function and use being identical to the zoom in/out feature explained here.

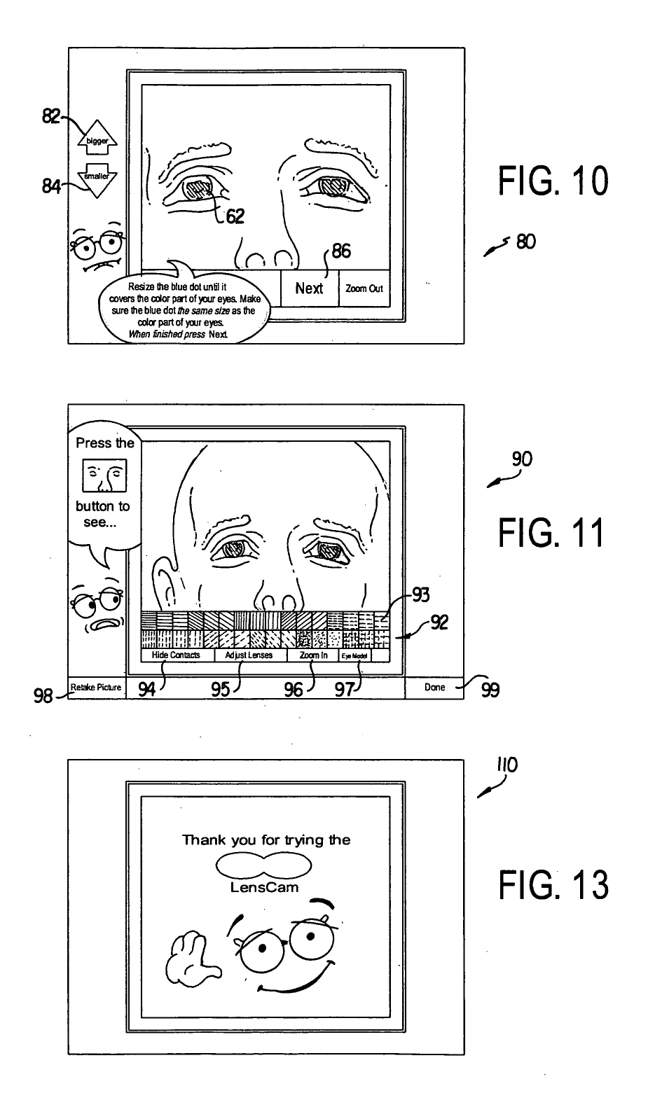

When the contact lenses 62 are properly positioned, the user touches the “Next” prompt 72, and proceeds to a resize step 80. An exemplary embodiment of this step is shown in FIG. 10. Here, the user resizes the contact lenses 62 to fit over the entire color portion of the user's eye. Two arrows, one labeled “bigger” 82 and the other labeled “smaller” 84 are provided at the side of the monitor 11. If the contact lenses 62 does not cover the entire eye of the user, the user can touch the “bigger” arrow 82 to increase the size of the contact lens 62. Similarly, if the contact lenses 62 are too large, the user can touch the “smaller” arrow 84 to decrease their size. After the contact lenses 62 are properly sized, the user touches the “Next” prompt 86 to continue.

After the contact lenses 62 have been properly positioned and sized, the user is given a color palette 92 to change the color of the contact lenses 62 in a preview step 90. An exemplary embodiment of this step is shown in FIG. 11. The color palette 92 is divided into multiple sections 93, with each section 93 assigned a different color representing an available color contact lens. The user can then touch the color section 93 he wishes to preview and the contact lenses 62 will change to the selected color. The user can preview any number of colors by simply touching another color section 93. When the user is finished previewing the different color contact lenses 62, the user can than inform a sales person of his or her selection.

The color sections 93 on the color palette 92 can be periodically updated to accurately represent the color contacts lenses that are available for sale. If a manufacturer discontinues a color or introduces a new color, the color palette 92 will be updated to indicate the change.

The preview step 90 includes several other options in addition to the color palette 92. The user can select a “hide contacts” prompt 94 to remove the contact lenses 62 from the user's eyes and view his or her face without the contact lenses 62. The “hide contacts” prompt 94 alternates with a “show contacts” prompt, which appears after the contacts lenses 62 are removed. The “show contacts” prompt replaces the contact lenses 62 onto the user's eyes.

The user can also select an “adjust lens” prompt 95 which takes the user back to step 70, where he can reposition and resize the contacts lenses 62. Additionally, a “zoom in” and “zoom out” prompt 96 is included which allows the user to alternate between a close up and distant picture of the user's face.

An “eye model” prompt 97 is included which will display a human model wearing color contacts lenses, the color of which the user can change by using the color palette 92, as explained above. The human model can be any gender and any race. This allows the user to view the color contact lenses on the face of a professional model for comparison with how the color contact lenses look on his own face.

Also, a “retake pictures” prompt 98 is provided so that if the user is not satisfied with his picture, he can go back to step 40, and begin the process of taking his picture over again.

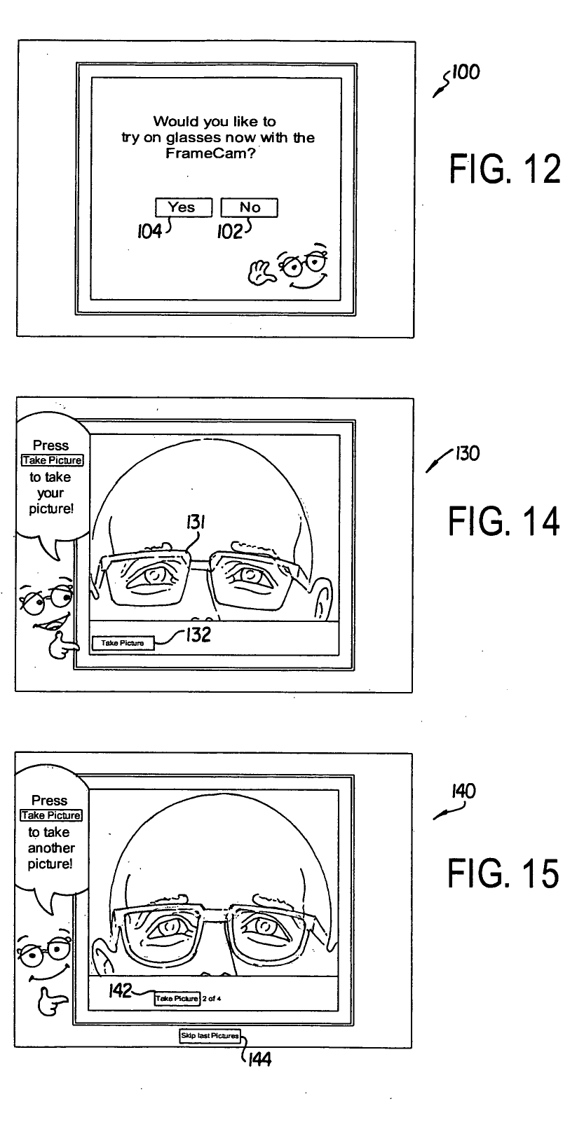

Lastly, after the user is finished previewing the various colors for the contact lenses 62, he can select the “Done” prompt 99. The program then proceeds to the next step 100 where he is asked whether he would like to try on eyeglass frames. An exemplary embodiment of step 100 is shown in FIG. 12. If the user selects the “No” prompt 102, the program displays a “Thank You” at step 110, thanking the user for using the lens camera system. An exemplary embodiment of the “Thank You” step 110 is shown in FIG. 13.

If the user selects the “Yes” prompt 104, the greeting for the frame camera system is displayed in step 120. The greeting for the frame camera system is similar to the greeting for the lens camera system of step 30, as shown in FIG. 5, with the wording modified to be applicable to the frame camera system.

Now turning to FIG. 3 which shows the steps in the frame camera system. After the frame camera system greeting, the program moves to a picturing taking step 130, where the monitor 11 streams video from the camera 12. An exemplary embodiment of the step 130 is shown in FIG. 14. Here again, the user will be sitting in front of the camera 12 and will position himself so that his face is displayed on the monitor 11.

In contrast to the lens camera system which uses virtual contact lenses, here the user will put on actual pairs of eyeglass frames 131 available in the office or store. The user will put on the eyeglass frame that he wishes to preview and position his face in front of the camera 12. The user will then select the “Take Picture” prompt 132, which performs a short countdown, and takes a picture of the user's face and displays it on the monitor 11. The onscreen assistance 26 provide instructions to assist the user in automatically moving between steps and screens.

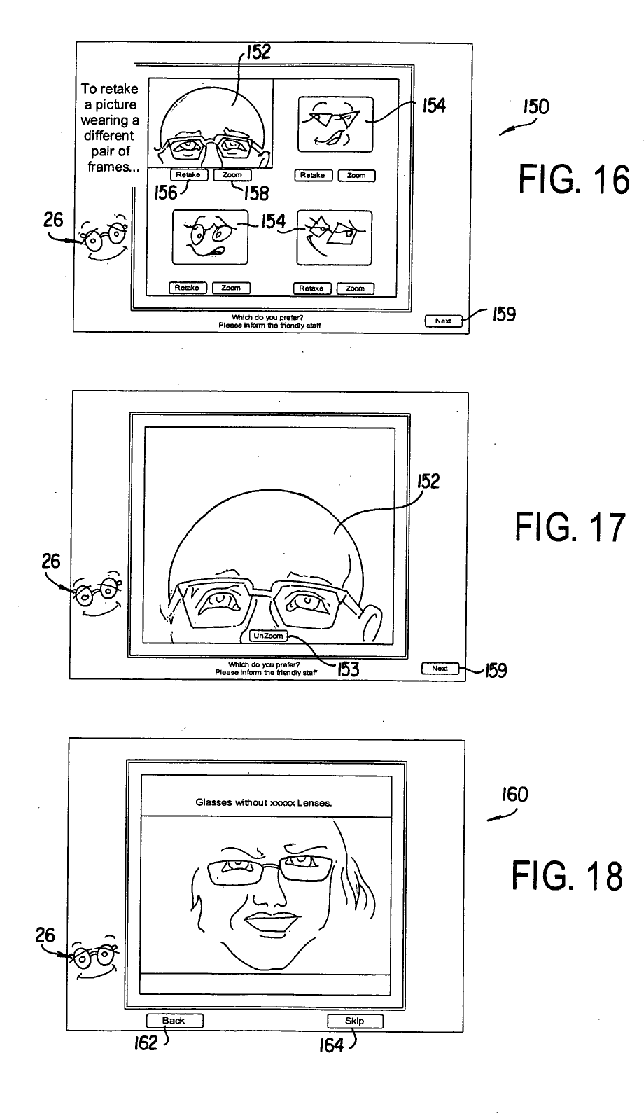

The frame camera system allows the user to preview multiple eye glass frames simultaneously, and therefore, prompts the user to take another picture in an additional picture step 140. An exemplary embodiment of step 140 is shown in FIG. 15. If the user wishes to try on a different eyeglass frame, he puts on the new eyeglass frame, positions himself in front of the camera 12, and selects the “Take Picture” prompt 142. In this way, step 140 is repeated until multiple pictures with multiple different eyeglass frames have been taken or until the user selects the “Skip to last Picture” prompt 144. If the user selects the “Skip to last Picture” prompt 144, he stops taking pictures and goes directly to the preview step 150. An exemplary embodiment of the preview step 150 is shown in FIG. 16. For example, four different images can be displayed in four quadrants of the screen.

In step 150, the pictures 152 taken by the user in the previous steps are placed in the four quadrants of the monitor 11 for review. If only a single picture 152 was taken, the one picture 152 is displayed in a quadrant of the monitor 11, with the other quadrants left empty or filled with amusing cartoon pictures, advertisements, or promotional messages 154. If any additional pictures were taken, they would be placed in one of the unused quadrants.

Under each picture is a “Retake” prompt 156 and a “Zoom” prompt 158. The “Retake” prompt 156 takes the user to previous picture taking step 130, allowing him to retake the picture. Selecting the “Zoom” prompt 158 under picture 152 enlarges the picture 152 to fill the display, as shown in FIG. 17. This allows the user to get a more detailed view of a particular picture 152 of interest. When the user has finished viewing the enlarged picture 152, he selects the “Unzoom” prompt 153, and is returned to the preview step 150, shown in FIG. 16.

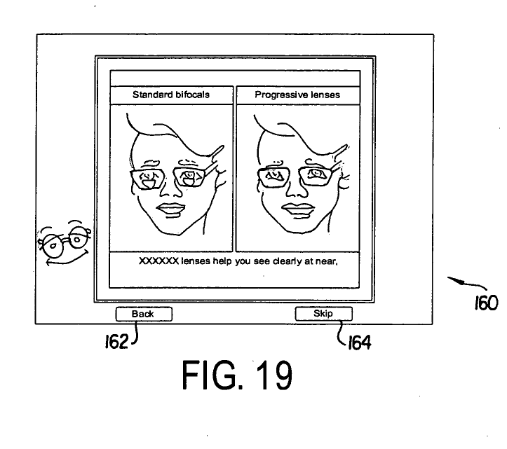

In either the zoomed (FIG. 16) or unzoomed (FIG. 17) frame, the user can select the “Next” prompt 159 when he is finished previewing eyeglass frames. An instructional or promotional video is then played at step 160, which informs the user on various topics relating to eyeglass selection, such as the types of lenses available and the brands available. Exemplary depictions of these promotional videos are shown in FIGS. 18 and 19. Additionally, during the playing of these videos, a “Back” prompt 162 and “Skip” prompt 164 can be selected to either go back to the previous step or skip the current video. Any number of these videos may be included during this step to inform the user on various topics of interest.

Furthermore, it should also be understood that videos of any type, including advertisements and displays of commercials brands and/or trademarks may be placed within any of the steps of either the lens camera or frame camera system.

After the last video has been played or skipped, and if the user has not already tried the lens camera system, the user is asked whether he is interested in color contacts in step 170 (analogous to step 100 discussed above and shown in FIG. 12). If the user is interested, he selects a “Yes” prompt and greeted by the lens camera greeting of step 30. If the user selects the “No” prompt, the frame camera system displays a “Thank You” in step 180 (analagous to the “Thank You” step 110, shown in FIG. 13) and then goes to the initial display screen of step 20 (shown in FIG. 4).

While particular embodiments have been chosen to illustrate the invention, it will be understood by those skilled in the art that various changes and modification can be made therein without departing from the scope of the invention as defined in the appended claims.

1. A method of previewing and selecting eyewear including a programmed computer that is interactive with a user, and a screen cooperating with the programmed computer, comprising the steps of:
obtaining a digital image of at least the face of the user;
displaying the digital image of the face of the user on the screen;
selecting a color;
superimposing the color on the digital image of the face of the user at one of the eyes of the face, thereby simulating the appearance of a colored contact lens on the eye of the user.

2. A method according to claim 1, further comprising the steps of:
selecting a second color; and
changing the color superimposed on the eye of the digital image based on the selected second color.

3. A method according to claim 2, further comprising the step of
displaying a color template on the screen and selecting the color from the color template.

4. A method according to claim 1, further comprising the steps of:
providing an instructional prompt on the screen instructing the user during each step of obtaining the digital image, displaying the image, selecting a color, and superimposing the color on the digital image.

5. A method according to claim 4, wherein
the instructional prompt includes instructions to the user in different languages.

6. A method according to claim 1, further comprising the step of:
marking the eye of the digital image of the face of the user prior to superimposing the color on the eye of the digital image.

7. A method according to claim 1, further comprising the step of:
prior to obtaining the digital image, instructing the user to select one of either colored contact lenses or frames.

8. A method according to claim 7, further comprising the step of:
after superimposing the color on the digital image, instructing the user to select the other of either contact lenses or frames.

9. A method according to claim 1, further comprising the step of:
after obtaining the digital image of the face of the user, obtaining a second digital image of the face of the user and display the second digital image on the screen instead of the first digital image.

10. A method according to claim 1, further comprising the step of:
adjusting the position of the color on the eye of the digital image of the face of the user.

11. A method according to claim 1, further comprising the step of:
adjusting the amount of the color on the eye of the digital image of the face of the user.

12. An automated method of previewing and selecting eyewear including a programmed computer that is interactive with a user, and a touch screen cooperating with the programmed computer, comprising the steps of:
obtaining a digital image of at least the face of the user and automatically displaying the digital image of the face of the user on the screen;
selecting a color and automatically superimposing the color selected by the user on the digital image of the face of the user at one of the eyes of the face, thereby simulating the appearance of a colored contact lens on the eye of the user; and
providing an instructional prompt on the screen automatically instructing the user during each step of obtaining the digital image, displaying the image, and superimposing the color on the digital image.

13. A method according to claim 12, further comprising the step of
touching the touch screen to move through the steps of obtaining a digital image, displaying the image, selecting a color and superimposing the color on the digital image.

14. A method according to claim 12, further comprising the step of
touching the digital image of the face at the eye to mark the eye prior to selecting the color and superimposing the color over the eye.

15. A method according to claim 12, wherein
the instructional prompt provides instructions to the user in different languages.

16. An automated method of previewing and selecting eyewear including a programmed computer that is interactive with a user, and a touch screen cooperating with the programmed computer, comprising the steps of:
obtaining a first digital image of at least the face of the user with a first pair of eyeglass frames worn by the user;
obtaining a second digital image of at least the face of the user with a second pair of eyeglass frames worn by the user;
displaying the first and second digital images together on the screen, thereby allowing the user to view both the first and second pairs of eyeglass frames as worn by the user; and
providing an instructional prompt on the screen automatically instructing the user during each step of obtaining the first and second digital images and displaying the first and second digital images.

17. A method according to claim 16, further comprising the steps of:
obtaining third and fourth digital images of at least the face of the user with third and fourth pair of eyeglass frames, respectively, worn by the user;
and displaying the third and fourth digital images with the first and second digital images on the screen, thereby allowing the user to view the first, second, third and fourth pairs of eyeglass frames as worn by the user.

18. A method according to claim 16, wherein
the instructional prompt provides instructions in different lanaguages.
